(19) United States
(12) Patent Application Publication
(10) Pub. No.: US 2018/0319935 A1
(43) Pub. Date: Nov. 8, 2018

(54) POLYMER STRUCTURE PRODUCED USING GASEOUS MOLECULAR LAYER DEPOSITION AND CLEAVABLE BY EXTERNAL STIMULUS, AND PRODUCTION METHOD THEREFOR

(71) Applicant: SOOKMYUNG WOMEN'S UNIVERSITY INDUSTRY ACADEMIC COOPERATION FOUNDATION, Seoul (KR)

(72) Inventors: Jin Seok Lee, Seoul (KR); Yi-Seul Park, Seoul (KR); Hyein Kim, Seoul (KR)

(21) Appl. No.: 16/029,891

(22) Filed: Jul. 9, 2018

Related U.S. Application Data
(63) Continuation of application No. PCT/KR2016/014858, filed on Dec. 19, 2016.

(30) Foreign Application Priority Data
Jan. 7, 2016 (KR) 10-2016-0001895

(51) Int. Cl. C08G 71/02; C08G 71/04; C09D 4/00

(52) U.S. Cl. CPC C08G 71/02; C09D 4/00; C08G 71/04

(57) ABSTRACT

The present invention relates to a polymer structure, comprising a base member, a polymer mediator formed by molecular layer deposition (MLD) on the base member, a linker formed on the mediator, and a transmitter bonded with the linker, wherein a bond between the linker and the transmitter is cleavable by an external stimulus.

### CROSS-REFERENCE TO RELATED APPLICATIONS

This application claims priority to Korean Patent Application No. 10-2016-0001895 filed on Jan. 7, 2016, which is hereby incorporated by reference.

### FIELD OF THE INVENTION

The present invention relates to a polymer structure cleavable by an external stimulus and a method of producing the same; and more particularly, to the polymer structure produced by molecular layer deposition and cleavable by the external stimulus and the method of producing the same.

### BACKGROUND OF THE INVENTION

Molecular layer deposition (MLD) is a method of depositing gaseous molecules capable of forming organic or organic-inorganic thin films in a shape of thin film on a substrate through chemical bonds between them. As a concept of extending to a molecular level atomic layer deposition (ALD) as an existing method known as a technique for producing the most ideal inorganic and metal oxide thin film capable of being controlled at an atomic layer level, the MLD is a technique capable of forming organic thin films or organic-inorganic hybrid nano ultrathin films, unlike the ALD under which formable substances are limited to inorganic metal thin films. Producing organic or inorganic molecules to be formed in a gaseous state and bonding them on a substrate in due order through self-limiting reaction, the MLD particularly has an advantage of forming a desired organic or organic-inorganic hybrid molecular layer uniformly. Because the MLD may easily design a structure and a nature of the deposited molecular layer on the substrate by controlling a deposition cycle, a reactant, a type of chemical bond, deposition count, etc. and control thickness of a thin film in a molecular level, it draws attention in a process of forming a variety of organic and organic-inorganic hybrid thin films.

### SUMMARY OF THE INVENTION

It is a technical object of the present invention to provide a polymer structure produced by molecular layer deposition and cleavable by an external stimulus.

It is the other technical object of the present invention to provide a method of producing a polymer structure cleavable by an external stimulus by using molecular layer deposition.

An embodiment of a polymer structure to resolve the technical object above in accordance with the present invention comprises:

a base member;

a polymer mediator formed by molecular layer deposition (MLD) on the base member;

a linker formed on the mediator; and

a transmitter bonded with the linker;

wherein a bond between the linker and the transmitter is cleavable by an external stimulus.

Another embodiment to resolve the technical object above in accordance with the present invention comprises:

a base member,

a polymer mediator formed by MLD on the base member, and

a transmitter bonded with the mediator,

wherein a bond between the mediator and the transmitter is cleavable by an external stimulus.

According to some embodiments of a polymer structure in accordance with the present invention, the linker can be formed by the MLD.

According to some embodiments of a polymer structure in accordance with the present invention, the linker can be formed as one molecular layer.

According to some embodiments of a polymer structure in accordance with the present invention, at least one bond forming the mediator is cleavable by an external stimulus.

According to some embodiments of a polymer structure in accordance with the present invention, any of the bond between the mediator and the transmitter and the bond forming the mediator, which are cleavable by the external stimulus, are cleavable by the same external stimulus.

According to some embodiments of a polymer structure in accordance with the present invention, the mediator can be a polymer thin film aligned in one direction.

According to some embodiments of a polymer structure in accordance with the present invention, the external stimulus can be a physical stimulus.

According to some embodiments of a polymer structure in accordance with the present invention, the physical stimulus can be at least one of light, heat, an electric signal, and a magnetic signal.

According to some embodiments of a polymer structure in accordance with the present invention, the external stimulus can be a chemical change.

According to some embodiments of a polymer structure in accordance with the present invention, the chemical change can be an acidic or alkaline environment.

According to some embodiments of a polymer structure in accordance with the present invention, the base member can be a nanostructure.

According to some embodiments of a polymer structure in accordance with the present invention, the nanostructure can be a nanowire.

According to some embodiments of a polymer structure in accordance with the present invention, the transmitter can be a drug.

According to some embodiments of a polymer structure in accordance with the present invention, the mediator can be formed on the base member whose surface is treated with plasma.

According to some embodiments of a polymer structure in accordance with the present invention, the mediator can be polyurea and the linker and the transmitter can be ester-bonded with each other.

According to some embodiments of a polymer structure in accordance with the present invention, the external stimulus can be an UV ray and the ester bond between the linker and the transmitter is cleaved by the UV ray.

According to some embodiments of a polymer structure in accordance with the present invention, the mediator can be polyester urethane and the mediator and the transmitter can be ester-bonded with each other.

According to some embodiments of a polymer structure in accordance with the present invention, the external stimulus can be an UV ray and the ester bond between the mediator and the transmitter is cleaved by the UV and at least one of C—O bonds in the polyester urethane is cleaved.

An embodiment of a method of producing polymer structure to resolve another technical object above in accordance with the present invention comprises steps of:

forming a polymer mediator on a base member by using MLD;

forming a linker on the mediator; and

bonding the linker and a transmitter;

wherein the bond between the linker and the transmitter is cleavable by an external stimulus.

Another embodiment of a method of producing polymer structure to resolve another technical object above in accordance with the present invention comprises steps of:

forming a polymer mediator on a base member by using MLD;

preparing a transmitter bonded with a linker; and

forming the transmitter bonded with the linker on the mediator to cause the linker to be placed between the mediator and the transmitter;

wherein the bond between the linker and the transmitter is cleavable by an external stimulus.

Yet another embodiment of a method of producing polymer structure to resolve another technical object above in accordance with the present invention comprises steps of:

forming a polymer mediator on a base member by using MLD; and

bonding the mediator and a transmitter;

wherein the bond between the mediator and the transmitter is cleavable by an external stimulus.

According to some embodiments of a method of producing polymer structure in accordance with the present invention, the linker can be formed on the mediator by using the MLD.

According to some embodiments of a method of producing polymer structure in accordance with the present invention, the linker can be formed as one molecular layer.

According to some embodiments of a method of producing polymer structure in accordance with the present invention, the transmitter bonded with the linker can be formed on the mediator by the MLD.

According to some embodiments of a method of producing polymer structure in accordance with the present invention, the transmitter can be bonded with the mediator by using the MLD.

According to some embodiments of a method of producing polymer structure in accordance with the present invention, at least one bond forming the mediator is cleavable by an external stimulus.

According to some embodiments of a method of producing polymer structure in accordance with the present invention, any bond cleavable by each external stimulus, among the bond between the mediator and the transmitter and the bond forming the mediator, can be cleaved by the same external stimulus.

According to some embodiments of a method of producing polymer structure in accordance with the present invention, the mediator can be formed to be aligned in one direction.

According to some embodiments of a method of producing polymer structure in accordance with the present invention, the transmitter can be bonded with the linker by using the MLD.

According to some embodiments of a method of producing polymer structure in accordance with the present invention, the external stimulus can be a physical stimulus.

According to some embodiments of a method of producing polymer structure in accordance with the present invention, the physical stimulus can be at least one of light, heat, an electric signal, and a magnetic signal.

According to some embodiments of a method of producing polymer structure in accordance with the present invention, the external stimulus can be a chemical change.

According to some embodiments of a method of producing polymer structure in accordance with the present invention, the chemical change can be an acidic or alkaline environment.

According to some embodiments of a method of producing polymer structure in accordance with the present invention, the base member can be a nanostructure.

According to some embodiments of a method of producing polymer structure in accordance with the present invention, the nanostructure can be a nanowire.

According to some embodiments of a method of producing polymer structure in accordance with the present invention, the transmitter can be a drug.

Some embodiments of a method of producing polymer structure in accordance with the present invention, can further include, before the step of forming the mediator, a step of performing plasma treatment of the surface of the base member.

According to some embodiments of a method of producing polymer structure in accordance with the present invention, the mediator can be polyurea and the linker and the transmitter can be ester-bonded with each other.

According to some embodiments of a method of producing polymer structure in accordance with the present invention, the mediator can be formed by using phenylenediisocyanate (PDI) and phenylenediamine (PDI) as precursors by the MLD.

According to some embodiments of a method of producing polymer structure in accordance with the present invention, the external stimulus can be an UV ray and the ester bond between the linker and the transmitter can be cleaved by the UV ray.

Some embodiments of a method of producing polymer structure in accordance with the present invention, can further include, before the step of forming the mediator, a step of treating the surface of the base member with oxygen plasma.

According to some embodiments of a method of producing polymer structure in accordance with the present invention, the mediator can be polyester urethane and the mediator and the transmitter can be ester-bonded with each other.

According to some embodiments of a method of producing polymer structure in accordance with the present invention, the mediator can be formed by using phenylenediisocyanate (PDI) and terephthalic acid bis-(2-hydroxy ethyl) ester (TBE) as precursors by the MLD.

According to some embodiments of a method of producing polymer structure in accordance with the present invention, the external stimulus can be an UV ray and the ester bond between the mediator and the transmitter is cleaved by the UV and at least one of C—O bonds in the polyester urethane can be cleaved.

Some embodiments of a method of producing polymer structure in accordance with the present invention, can further include, before the step of forming the mediator, a step of treating the surface of the base member with oxygen plasma.

### BRIEF DESCRIPTION OF THE DRAWINGS

The drawings attached below to explain example embodiments of the present invention are only part of example embodiments of the present invention and other drawings may be obtained based on the drawings without inventive work for those skilled in the art:

FIG. 1 is a drawing exemplarily representing one example embodiment of a polymer structure in accordance with the present invention.

FIG. 2 is a drawing schematically representing a process of depositing a transmission mediator of one example embodiment of a polymer structure by using molecular layer deposition (MLD) in accordance with the present invention.

FIG. 3 is an image of a transmission electron microscope (TEM) of polyurea by using MLD.

FIG. 4 is a drawing for explanation through comparison of cases of forming a polymer on a nanostructure by using MLD and by existing methods.

FIG. 5 is a sketchy drawing to explain that a polymer structure is cleaved by an external stimulus in one example embodiment of the present invention.

FIG. 6 is a drawing schematically representing another example embodiment of a polymer structure in accordance with the present invention.

FIG. 7 is a drawing roughly showing a process of depositing a transmission mediator of another example embodiment of a polymer structure by using MLD in accordance with the present invention.

FIG. 8 is a sketchy drawing to explain that a polymer structure in accordance with another example embodiment of the present invention is cleaved by an external stimulus.

FIG. 9 is a flowchart illustrating performance of one example embodiment of a method of producing a polymer structure in accordance with the present invention.

FIG. 10 is a flowchart illustrating performance of another example embodiment of a method of producing a polymer structure in accordance with the present invention.

FIG. 11 is a flowchart illustrating performance of another example embodiment of a method of producing a polymer structure in accordance with the present invention.

### DETAILED DESCRIPTION OF THE PREFERRED EMBODIMENTS

Hereinafter, exemplary embodiments of the present invention are described in detail with reference to the accompanying drawings.

Exemplary embodiments of the present invention are provided to further completely describe the present invention to a person of ordinary skill in the art, and the following exemplary embodiments may be changed to several different forms, and the scope of the present invention is not limited to the following exemplary embodiments. These exemplary embodiments enable to further complete the present disclosure and are provided to completely transfer the spirit of the present invention to a person of ordinary skill in the art.

In the drawings, a shown shape may be changed according to, for example, production technology and/or tolerance. Therefore, an exemplary embodiment of the present invention is not limited to a specific shape of an area shown in this specification but should include, for example, a shape change that may occur when producing. Like reference numerals designate like elements throughout the specification. Further, various elements and areas in the drawings are schematically shown. Therefore, the present invention is not limited to a relative size or gap shown in the accompanying drawings.

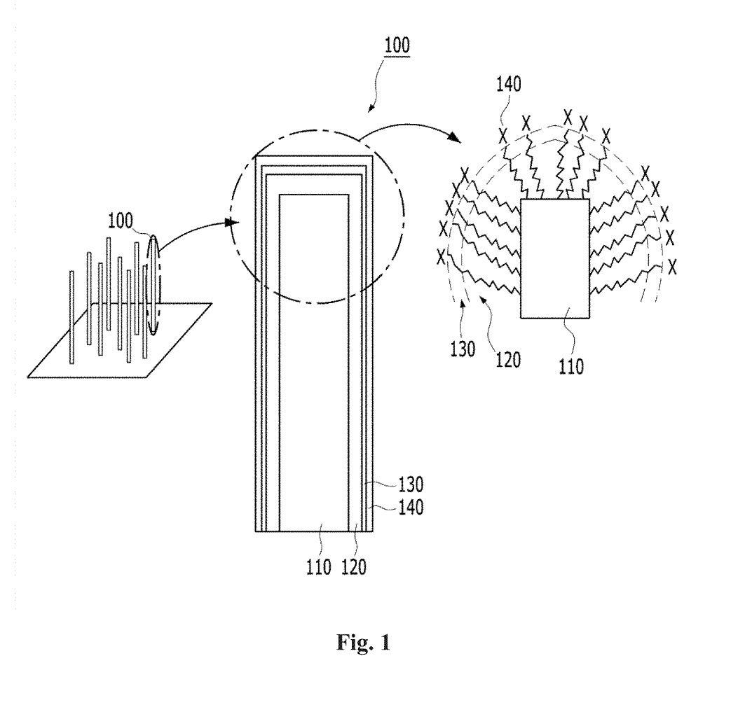

FIG. 1 is a drawing exemplarily representing one example embodiment of a polymer structure in accordance with the present invention.

By referring to FIG. 1, the one example embodiment 100 of the polymer structure in accordance with the present invention comprises a base member 110, a transmission mediator 120, a linker 130, and a transmitter 140.

The base member 110 determines a shape of the polymer structure 100 and supports the transmission mediator 120, the linker 130, and the transmitter 140. The base member 110 may be a nanostructure, and more desirably, a nanowire. The nanowire may consist of silicon, a carbon nanotube, etc. The surface of the base member 110 may be treated with plasma. At the time, the plasma may be oxygen plasma. As the surface of the base member 110 is treated by the plasma and a desired functional group is formed on the surface of the base member 110, the transmission mediator 120 which will be explained later may be much easier to be formed. In this example embodiment, it has been illustrated and explained that the base member 110 is a nanostructure in a shape of nanowire, but it is not limited to this. It may be a shape of flat substrate or a substrate, or structure with nanoparticles or patterns.

The transmission mediator 120 is formed on the base member 110. The transmission mediator 120 is made of polymer and it is formed by MLD. Thereby, the transmission mediator 120 may be formed in a shape aligned in one direction.

The MLD is a method of forming a molecular layer by supplying two or more molecules by turns through accurate chemical bonding and it may allow the molecular layer with high alignment degree to be formed. The MLD may form uniform thin films in a shape aligned wholly even on a flat surface as well as a substrate or nanostructure with patterns and has very stable characteristics because both substrates and molecules or molecules are connected to each other through strong chemical bonding. Besides, as the MLD stacks up molecular layers one by one on the surface of the nanostructure, a polymer thin film may be formed while the shape of nanostructure is maintained as it is.

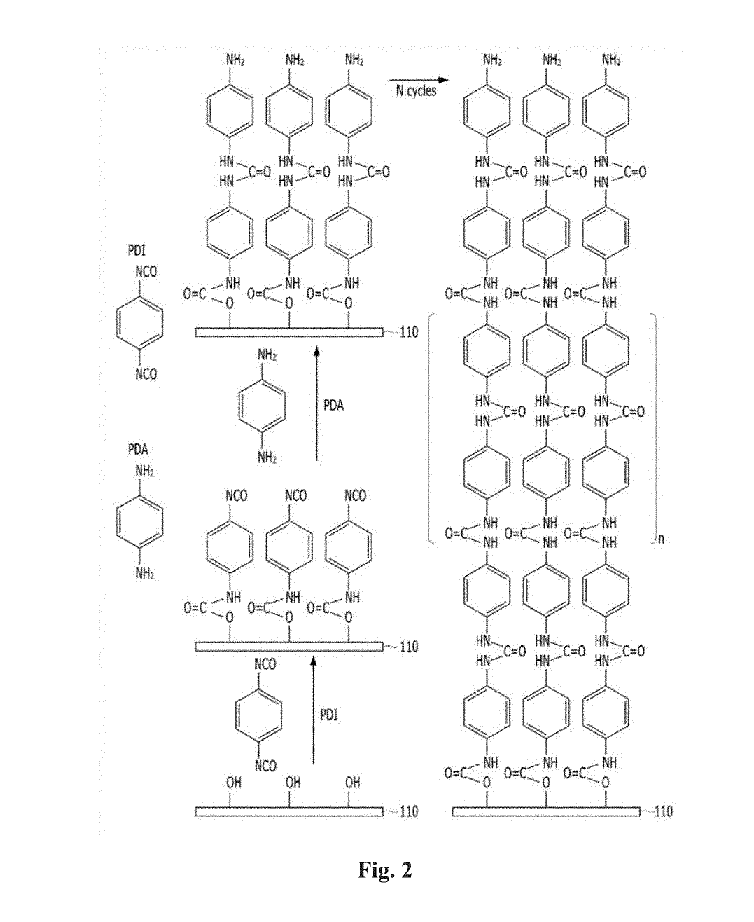

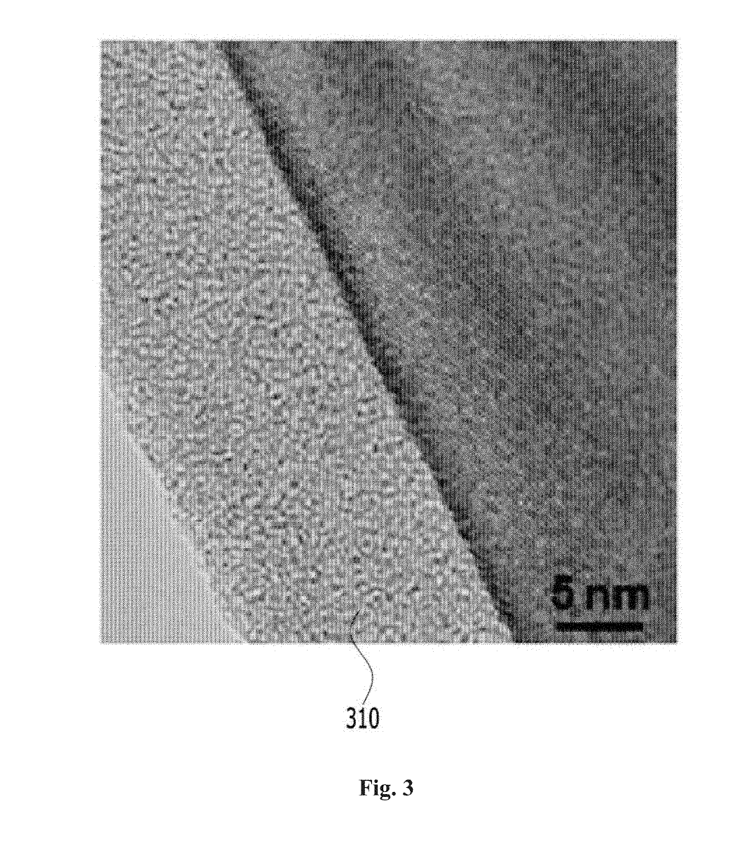

A sketchy drawing of a deposited thin film as well as a process of depositing the transmission mediator 120 by using the MLD is illustrated in FIG. 2. FIG. 2 represents the process of depositing the polyurea polymer mediator 120 by reciprocally supplying phenylenediisocyanate (PDI) and phenylenediamine (PDA) on the base member 110. An image of a transmission electron microscope (TEM) of a polyurea thin film 310 deposited is illustrated in FIG. 3.

Before the polyurea film is deposited, the surface of the base member 110 is treated with oxygen plasma to make hydroxyl radicals, OH, formed on the surface of the base member 110 as shown in FIG. 2.

The process of depositing the polyurea thin film by using the MLD is made in a form of supplying two precursors PDI and PDA by turns in a chamber at a high vacuum state. The individual precursors are supplied and evacuated to the chamber through four steps: dosing, exposure, purge, and evacuation. Dosing is a step of supplying a precursor on a nanostructure and exposure is a step of bonding the supplied precursor with the nanostructure. Purge is a step of removing a reactant not bonded with the nanostructure, through which an inert purge gas such as argon or nitrogen is supplied. At the time, carrier gas may be used as the purge gas. Evacuation is a step of making the chamber vacuum again. When each of the PDI and the PDA goes through the four steps as a process, one molecular layer of urea is formed on the nanostructure as illustrated in FIG. 2 and this process corresponds with one cycle. When the one cycle is performed repeatedly, polyurea which has desired number of molecular layers may be formed on the nanostructure. It may be found out that the polyurea polymer thin film 310 deposited in such a method is very dense and uniform as shown in FIG. 3.

When the MLD is used, the polymer thin film aligned in one direction, as illustrated in FIG. 2, may be formed. In addition, when the MLD is used, the thickness of the thin film deposited by each cycle is uniform, and thus, it is possible to control the number of deposition cycles by adjusting desired thickness of the thin film to nanoscale. Furthermore, as the thin film is deposited through a self-limiting reaction that leads molecular layers one by one to be deposited on the surface, the polymer thin film may be deposited while the shape of the nanostructure is maintained as it is. As illustrated in FIGS. 2 and 3, the surface of the formed polymer thin film becomes uniform. As functional groups formed on the surface are aligned uniformly, and desirable functional groups may be placed on the surface of the polymer thin film by adjusting types of precursors and chemical bonds, characteristics of the surface of the polymer thin film may be easily adjusted.

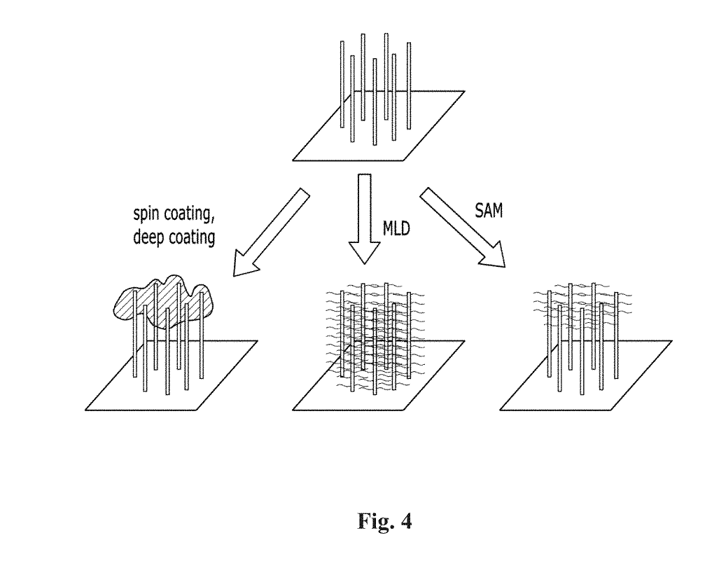

FIG. 4 is a drawing showing comparison of cases of forming a polymer in a nanostructure by using MLD and by the existing methods.

As illustrated in the image in the center of FIG. 4, when the polymer is formed on the nanostructure by using the MLD, the uniform polymer thin film is deposited while the shape of nanostructure is maintained as it is. On the contrary, methods such as spin coating or deep coating are deposition method not by controlled chemical bonding but by electrostatic attraction. Therefore, as illustrated in a left drawing of FIG. 4, ununiform polymer is formed and the shape of the nanostructure is deprived. Because a deposition method using a self-assembled monolayer (SAM) is made in a solution, as illustrated in a right drawing of FIG. 4, the polymer is formed partially only on the top of the nanostructure due to penetration limitation of molecules and it is, therefore, difficult to deposit uniform polymer thin films.

In the end, when the transmission mediator 120 is formed by using the MLD, it is possible to form the transmission mediator 120 while the shape of the base member 110 is maintained, the molecular layer of the transmission mediator 120 formed may be aligned in one direction and a functional group of the surface may be uniformly formed.

The linker 130 is formed on the transmission mediator 120. The linker 130 may be formed as one molecular layer. To do so, the linker 130 may be formed on the transmission mediator 120 capable of being deposited in a unit of molecular unit by using the MLD.

The transmitter 140 is bonded with the linker 130 and the bond between the linker 130 and the transmitter 140 is cleavable by an external stimulus. In other words, as the bond between the transmitter 140 and the linker 130 is cleaved by the external stimulus, the transmitter 140 is separated from the polymer structure 100. The transmitter 140 may be protein, DNA, RNA, a drug, etc. and if the transmitter 140 is a drug, the polymer structure 100 may be used as a drug delivery substance.

The external stimulus may be a physical stimulus such as light, heat, an electric signal, and a magnetic signal. A single physical stimulus or combinations of multiple types of physical stimuli may be provided to the polymer structure 100. In short, both the transmitter 140 and the linker 130 may be made of substances which may cause the bond between the transmitter 140 and the linker 130 to be cleavable by the physical stimulus. For example, the transmitter 140 and the linker 130 may be made of ester-bonded substances and both may be bonded to cause the ester bond therebetween to be cleavable by an UV ray.

Besides, the external stimulus may be a chemical change. The chemical change may be an acidic or alkaline environment. In brief, both the transmitter 140 and the linker 130 may be made of substances which may cause the bond between the transmitter 140 and the linker 130 to be cleavable by the chemical change such as pH change.

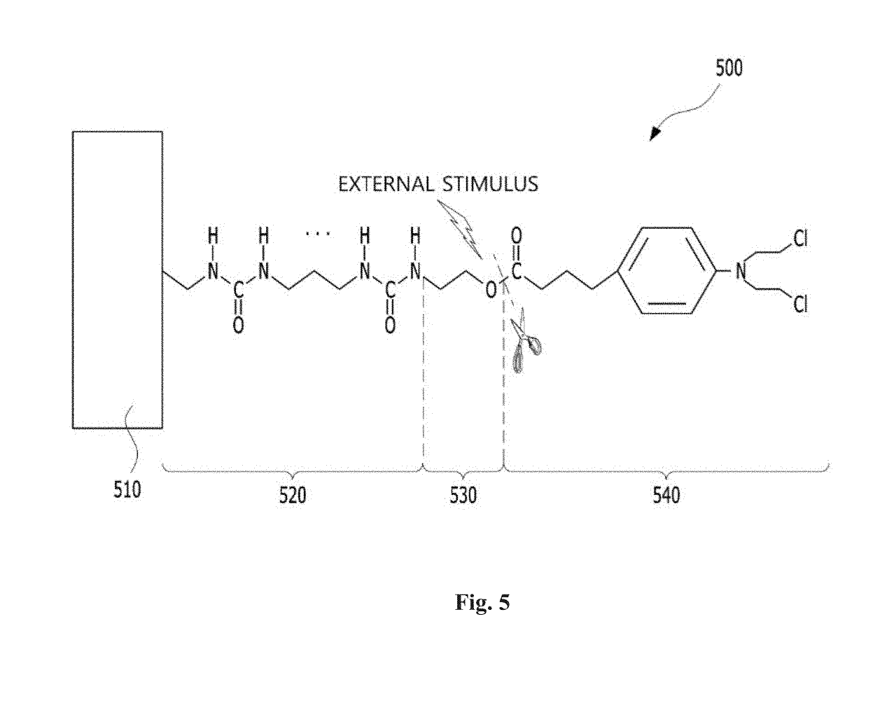

FIG. 5 is a sketchy drawing to explain that a polymer structure is cleaved by an external stimulus in one example embodiment of the present invention.

A polymer structure 500 consisting of a polyurea transmission mediator 520, a linker 530, and a transmitter 540 as a drug for leukemia such as chlorambucil that are formed in due order on a silicon nanowire 510 is illustrated in FIG. 5. At the time, the linker 530 and the transmitter 540 are ester-bonded with each other. As such, the polymer structure 500 may be produced by forming the polyurea transmission mediator 520 on the silicon nanowire 510 by MLD and forming the linker 530 as one molecular layer on the surface of the polyurea transmission mediator 520 by the MLD, thereby ester-bonding the transmitter 540 as the drug for leukemia with the linker 530. Otherwise, it may be produced by forming the polyurea transmission mediator 520 on the silicon nanowire 510 by the MLD and forming the transmitter 540 bonded with the linker 530 on the transmission mediator 520 by the MLD.

As illustrated in FIG. 5, when an UV ray with a special wavelength as an external stimulus is shot to the polymer structure 500 for a certain time, an ester bond between the linker 530 and the transmitter 540 is cleaved and the transmitter 540 as the drug for leukemia is separated from the polymer structure 500. For example, when an UV ray with a wavelength of roughly 350 nm is provided to the polymer structure 500 and a C—O bond from the ester bond between the linker 530 and the transmitter 540 is cleaved, as illustrated in FIG. 5, the transmitter 540 as the drug for leukemia is separated from the polymer structure 500. In FIG. 5, it has been illustrated and explained that the bond is cleaved by light, but it is not limited to this. It is natural that a bond between the linker and the transmitter cleavable by a physical stimulus such as heat, an electric signal, and a magnetic signal may be used. In addition, a bond between the linker and the transmitter cleavable by a chemical change such as pH change may be also used.

As illustrated in FIG. 5, the transmitter 540 may be separated from the polymer structure 500 of one example embodiment in accordance with the present invention because the bond between the linker 530 and the transmitter 540 is cleaved easily by a specific external stimulus (wherein light as the external stimulus has been illustrated and explained in FIG. 5 but it is not limited to this) by bonding the one linker 530 with the one transmitter 540 and also by bonding the one linker 530 with the transmission mediator 520 aligned in one direction by the MLD. When strength of the external stimulus, etc. is adjusted by using this, it is easy to control a time and amount of separating the transmitter 540. Accordingly, the polymer structure 500 in accordance with one example embodiment of the present invention is available in a field of drug delivery where it is important to control the time and amount of separating the transmitter 840, and also in other various fields.

On the contrary, when a transmission mediator and a linker are formed in an existing method such as spin coating or deep coating, the transmission mediator may be bonded complicatedly with the linker because it is randomly oriented without directivity and the degree of the bond between the linker and the transmission mediator is not uniform. Accordingly, it is very slow or impossible to cleave the transmitter by an external stimulus. Even if the transmitter is cleaved by the external stimulus, it would be impossible to control a time of separation and separated amount, and therefore, it would be unavailable in the field, e.g., drug delivery, where such control is important.

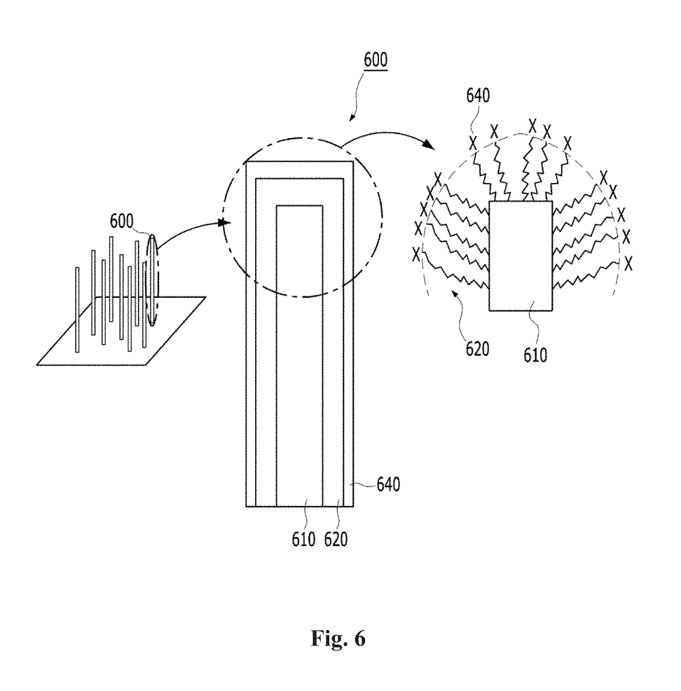

FIG. 6 is a drawing schematically representing another example embodiment of a polymer structure in accordance with the present invention.

By referring to FIG. 6, the another example embodiment 600 of the polymer structure in accordance with the present invention comprises a base member 610, a transmission mediator 620, and a transmitter 640.

The base member 610 determines a shape of the polymer structure 600 and supports the transmission mediator 620 and the transmitter 640. As the base member 610 in the example embodiment 600 has the same shape and functions as the base member 110 in the example embodiment 100 as stated above, detailed explanation is same as that on the base member 110. In other words, the base member 610 may be a nanostructure, and more desirably, a nanowire. The surface of the base member 610 may be treated with plasma. At the time, the plasma may be oxygen plasma. In this example embodiment, it has been illustrated and explained that the base member 610 is a nanostructure in a shape of nanowire, but it is not limited to this. It may be a shape of flat substrate or substrate, or structure with nanoparticles or patterns.

The transmission mediator 620 is formed on the base member 610. The transmission mediator 620 is made of polymer and it is formed by MLD. This may cause the transmission mediator 620 to be formed in a shape aligned in one direction.

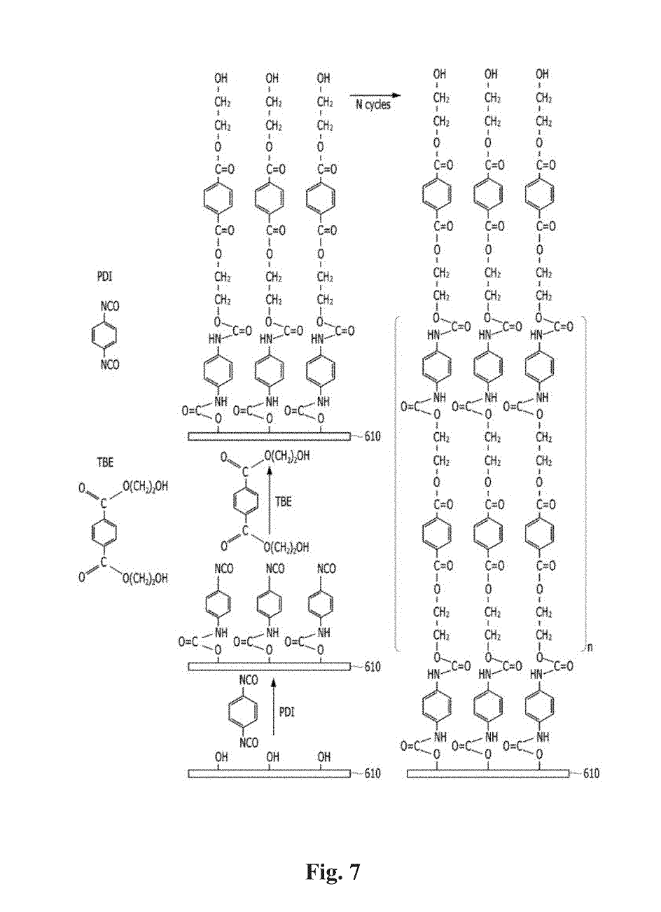

A sketchy drawing of a deposited thin film as well as a process of depositing the transmission mediator 620 by using the MLD is represented in FIG. 7. FIG. 7 illustrates a process of depositing the polyurea polymer mediator 620 on the base member 610 by reciprocally supplying phenylenediisocyanate (PDI) and terephthalic acid bis-(2-hydroxy ethyl) ester (TBE).

Before polyester urethane is deposited, the surface of the base member 610 is treated with oxygen plasma to make hydroxyl radicals (OH) formed on the surface of the base member 610 as illustrated in FIG. 7.

The process of depositing polyester urethane by using the MLD is made in a form of supplying the PDI and the TBE as two precursors by turns in a chamber at a high vacuum state. The individual precursors are supplied to the chamber through four steps: dosing, exposure, purge, and evacuation. Dosing, exposure, purge, and evacuation are the same as the steps as explained above. When each of the PDI and the TBE goes through the four steps as a process, one ester urethane molecular layer is formed on the nanostructure as illustrated in FIG. 7 and this process corresponds with one cycle. When the cycle is performed repeatedly, polyester urethane which has desired number of molecular layers may be formed on the base member 610.

As such, when polyester urethane is deposited by using the MLD, the polymer thin film aligned in one direction may be formed, as illustrated in FIG. 7. It is possible to adjust desired thickness of the thin film to nanoscale by adjusting the number of deposition cycles because the thickness of the thin film deposited by each cycle is uniform. The polyester urethane polymer thin film may be deposited on the nanostructure while the shape of nanostructure is maintained as it is.

Finally, as explained above, when the transmission mediator 620 is formed by using the MLD, it is possible to form the transmission mediator 620 while the shape of the base member 610 is maintained and the molecular layer of the transmission mediator 620 formed may be aligned in one direction. Additionally, functional groups of the surface may be formed uniformly.

The transmitter 640 is bonded with the transmission mediator 620 and a bond between the transmission mediator 620 and the transmitter 640 is cleavable by an external stimulus. In other words, as the bond between the transmitter 640 and the transmission mediator 620 is cleaved by the external stimulus, the transmitter 640 is separated from the polymer structure 600. The transmitter 640 may be protein, DNA, RNA, a drug, etc. and if the transmitter 640 is a drug, the polymer structure 600 may be used as a drug delivery substance. The transmission mediator 620 may be formed to allow at least one of bonds making the transmission mediator 620 as well as the bond between the transmission mediator 620 and the transmitter 640 to be cleavable by an external stimulus. At the time, the bond between the transmission mediator 620 and the transmitter 640 or the bonds making the transmission mediator 620 are cleavable by the same type of external stimulus provided to the polymer structure 600. In other words, the transmitter 640 may be separated from the polymer structure 600 in a shape of all partial cleavages between the transmission mediator 620 and the transmitter 640 which are formed on the base member 610 by cleaving several bonds, including the bond between the transmission mediator 620 and the transmitter 640 and multiple bonds in the transmission mediator 620, by one external stimulus.

The external stimulus may be a physical stimulus such as light, heat, an electric signal, and a magnetic signal. A single physical stimulus or combinations of multiple types of physical stimuli may be provided to the polymer structure 600. In short, both the transmitter 640 and the transmission mediator 620 may be made of substances which may cause the bond between the transmitter 640 and the transmission mediator 620 to be cleavable by the physical stimulus. For example, the transmitter 140 and the transmission mediator 620 may be made of ester-bonded substances and may be bonded to cause the ester bond to be cleavable by an UV ray.

Besides, the external stimulus may be a chemical change. The chemical change may be an acidic or alkaline environment. In brief, both the transmitter 640 and the transmission mediator 620 may be made of substances which may cause the bond between the transmitter 640 and the transmission mediator 620 to be cleavable by the chemical change such as pH change.

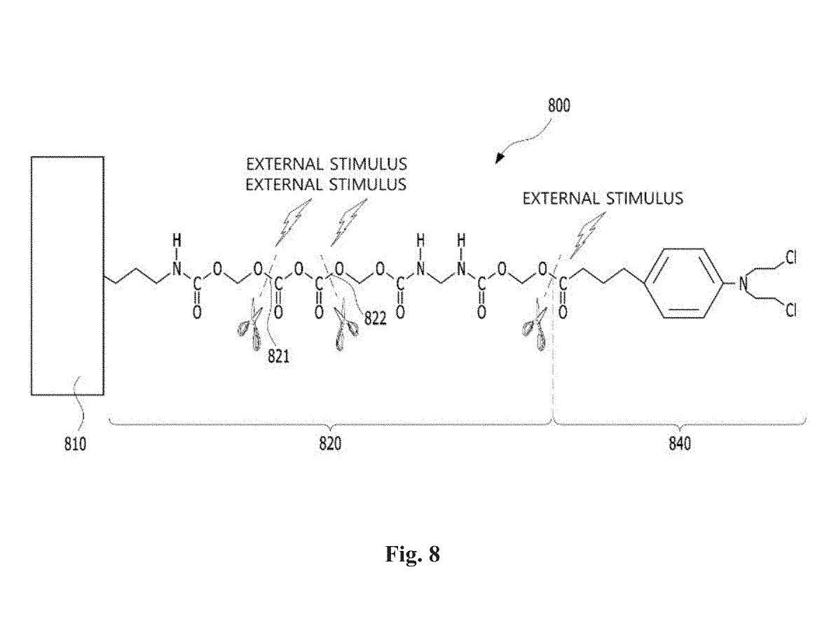

FIG. 8 is a sketchy drawing to explain that a polymer structure in accordance with another example embodiment of the present invention is cleaved by an external stimulus.

A polymer structure 800 in which a polyester urethane transmission mediator 820, and a transmitter 840 as a drug for leukemia such as chlorambucil are formed in due order on a silicon nanowire 810 is illustrated in FIG. 8. At the time, the transmission mediator 820 and the transmitter 840 are ester-bonded with each other. As such, the polymer structure 800 may be produced by forming the polyester urethane transmission mediator 820 on the silicon nanowire 810 by MLD and ester-bonding the transmitter 840 as the drug for leukemia with the transmission mediator 820.

As illustrated in FIG. 8, when an UV ray with a special wavelength, as an external stimulus, is shot to the polymer structure 800 for a certain time, an ester bond between the transmission mediator 820 and the transmitter 840 is cleaved and the transmitter 840 as the drug for leukemia is separated from the polymer structure 800. For example, when an UV ray with a wavelength of roughly 350 nm is provided to the polymer structure 800, and a C—O bond from the ester bond between the transmission mediator 820 and the transmitter 840 is cleaved, as illustrated in FIG. 8, the transmitter 840 as the drug for leukemia is separated from the polymer structure 800. By the way, when the transmission mediator 820 is made of polymer such as polyester urethane, multiple C—O bonds in polyester urethane exist. Therefore, the C—O bonds existing in polyester urethane may be cleaved by an UV ray with a wavelength of roughly 350 nm. For example, as illustrated in FIG. 8, C—O bonds in polyester urethane marked as reference nos. 821 and 822 may be cleaved by an UV ray with a wavelength of roughly 350 nm. In short, the transmitter 840 as a protein therapeutics may be separated from the polymer structure 800 by partially cleaving all C—O bonds in polyester urethane as well as the ester bond between the polyester urethane transmission mediator 820 and the transmitter 840 by one external stimulus as the UV ray with the wavelength of 350 nm.

In FIG. 8, it has been illustrated and explained that the bond is cleaved by light, but it is not limited to this. It is natural that a bond between the transmission mediator and the transmitter cleavable by a physical stimulus such as heat, an electric signal, and a magnetic signal may be used.

In addition, a bond between the transmission mediator and the transmitter cleavable by a chemical change such as pH change may be also used.

As illustrated in FIG. 8, the transmitter 840 may be separated from the polymer structure 800 as one example embodiment in accordance with the present invention because the bond between the transmission mediator 820 and the transmitter 840 and the bonds in the transmission mediator 820 are cleaved easily by a specific external stimulus (wherein light as the external stimulus has been illustrated and explained in FIG. 8 but it is not limited to this) by bonding the transmitter 840 with the transmission mediator 820 aligned in one direction by the MLD. When strength of the external stimulus, etc. is adjusted by using this, it is easy to control a time and amount of separating the transmitter 840. Accordingly, as explained above, this example embodiment is available in a field of drug delivery where it is important to control the time and amount of separating the transmitter 840, and also in other various fields.

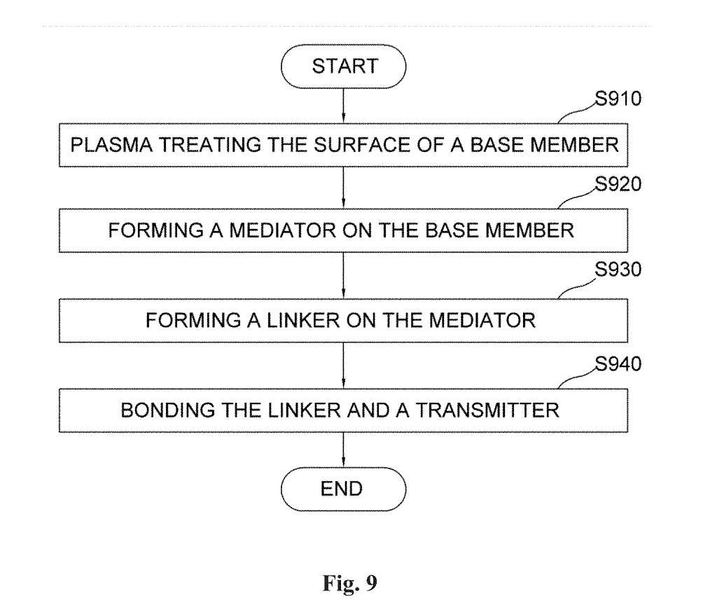

FIG. 9 is a flowchart representing performance of one example embodiment of a method of producing a polymer structure in accordance with the present invention.

By referring to FIG. 9, in the example embodiment of the method of producing the polymer structure, a surface of the base member 110, first of all, may be treated with plasma at S910. At the time, the plasma may be oxygen plasma.

The base member 110 has the same shape and functions as the base member illustrated and explained in FIG. 1. It determines the shape of the polymer structure 100 and it may be a nanostructure, and more desirably, a nanowire. The transmission mediator 120 may be formed more easily by causing the surface of the base member 110 to have desired functional groups through plasma treatment. For example, the surface of the base member 110 may be treated with oxygen plasma to form hydroxyl radicals on the surface of the base member 110. If the desired functional groups are formed on the surface of the base member 110, a step S910 may be omitted.

After that, the transmission mediator 120 is formed on the base member 110 at S920. The transmission mediator 120 is made of polymer and it is formed by the MLD. This may cause the transmission mediator 120 to be formed in a shape aligned in one direction. For example, PDI and PDA may be reciprocally supplied to form polyurea polymer, which is the transmission mediator 120, on the base member 110 by the MLD in a shape aligned in one direction. A method of forming the polyurea transmission mediator 120 by the MLD is the same as the method illustrated and explained in FIG. 2. As such, if the MLD is used, the transmission mediator 120 aligned in one direction may be formed on the base member 110.

Next, the linker 130 is formed on the transmission mediator 120 at S930. The linker 130, which has the same shape and functions as the linker illustrated and explained in FIG. 1, may be formed as one molecular layer. To form the linker 130 as one molecular layer, the MLD that may allow deposition in a unit of molecular layer may be used.

After that, the linker 130 and the transmitter 140 are bonded with each other at S940. As the transmitter 140 has the same shape and functions as the transmitter illustrated and explained in FIG. 1, the transmitter 140 and the linker 130 may be bonded with each other by using the MLD. This may cause the polymer structure 100 where the transmission mediator 120, the linker 130 and the transmitter 140 are formed in due order on the base member 110 to be produced. To cleave the bond between the linker 130 and the transmitter 140 by an external stimulus, a step S940 is performed. The transmitter 140 may be protein, DNA, RNA, a drug, etc. and if the transmitter 140 is a drug, the polymer structure 100 may be used as a drug delivery substance.

As such, when the external stimulus is provided to the formed polymer structure 100, the bond between the linker 130 and the transmitter 140 is cleaved and the transmitter 140 is separated from the polymer structure 100. At the time, the external stimulus may be a physical stimulus such as light, heat, an electric signal, and a magnetic signal. A single physical stimulus or combinations of multiple types of physical stimuli may be provided to the polymer structure 100. In short, both the transmitter 140 and the linker 130 may be made of substances which may cause the bond between the transmitter 140 and the linker 130 to be cleavable by the physical stimulus. For example, the transmitter 140 and the linker 130 may be formed to make the bond between the transmitter 140 and the linker 130 cleavable by an UV ray. In brief, a step S940 may be performed to ester-bond the transmitter 140 with the linker 130. When an UV ray with a wavelength of 350 nm is provided to the polymer structure 100 produced by performing the steps S920 to S940 have been performed to make the linker 130 and the transmitter 140 ester-bonded with each other on condition that the transmission mediator 120 is polyurea, a C—O bond from the ester bond between the linker 130 and the transmitter 140 may be cleaved and the transmitter 140 may be separated from the polymer structure 100.

In addition, the external stimulus may be a chemical change. The chemical change may be an acidic or alkaline environment. In short, the transmitter 140 and the linker 130 may be bonded with each other to make the bond between the transmitter 140 and the linker 130 cleavable by a chemical change such as pH change at the step S940.

When the polymer structure 100 is produced by using the method illustrated in FIG. 9, the linker 130 is formed on the transmission mediator 120 aligned in one direction by the MLD and the transmitter 140 is bonded with the linker 130. Therefore, the bond between the linker 130 and the transmitter 140 may be cleaved easily by the external stimulus and the polymer structure 100 where the transmitter 140 is cleavable may be produced. The polymer structure 100 from which it is easy to control a time and amount of separating the transmitter 140 by adjusting strength of the external stimulus, etc. may be produced. Accordingly, the method of producing this example embodiment is available in a field of drug delivery where it is important to control the time and amount of separating the transmitter 140, and also in other various fields.

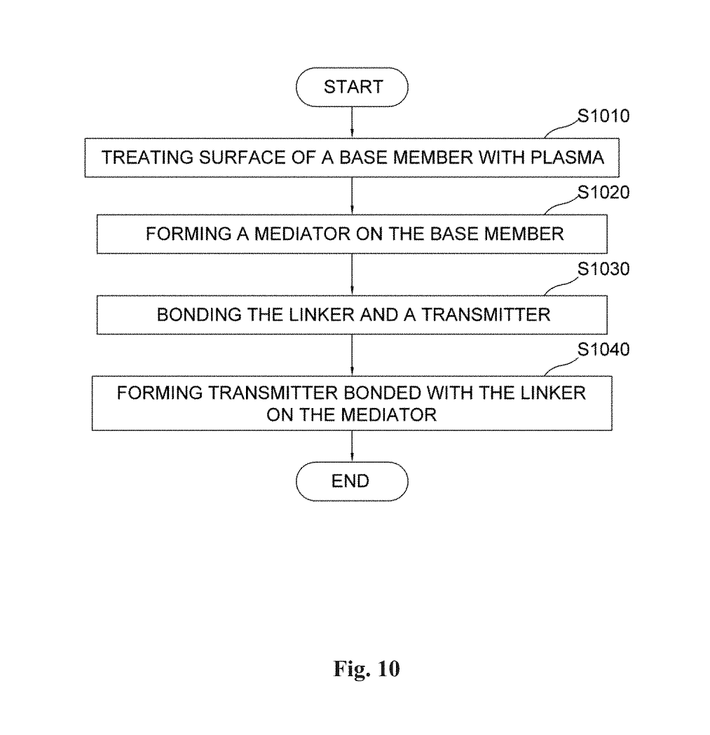

FIG. 10 is a flowchart representing performance of another example embodiment of a method of producing a polymer structure in accordance with the present invention.

By referring to FIG. 10, in another example embodiment of the method of producing the polymer structure in accordance with the present invention, first of all, the surface of the base member 110 is treated with plasma at S1010 and then the transmission mediator 120 is formed on the base member 110 at S1020. As steps S1010 and S1020 correspond to the steps S910 and S920, respectively, detailed explanation on them is omitted.

Next, the linker 130 and the transmitter 140 are bonded with each other at S1030. The step S1030, as a step performed separately from the steps S1010 and S1020, may be performed before the step S1010, between the steps the steps S1010 and S1020, or with the steps S1010 and S1020 at the same time.

As the linker 130 and the transmitter 140 has the same shape and functions as the linker and the transmitter as illustrated and explained in FIG. 1, the linker 130 and the transmitter 140 may be bonded with each other in a solution. The step S1030 is performed to make the bond between the linker 130 and the transmitter 140 cleavable by an external stimulus. The transmitter 140 may be protein, DNA, RNA, a drug, etc. and if the transmitter 140 is a drug, the polymer structure 100 may be used as a drug delivery substance.

Next, the transmitter 140 bonded with the linker 130 is formed on the transmission mediator 120 at S1040. At the time, a step S1040 is performed to cause the linker 130 to be placed between the transmission mediator 120 and the transmitter 140. This may cause the polymer structure 100 where the transmission mediator 120, the linker 130, and the transmitter 140 are formed in due order on the base member 110 to be produced.

As such, when an external stimulus is provided to the polymer structure 100 produced, the bond between the linker 130 and the transmitter 140 is cleaved and then the transmitter 140 is separated from the polymer structure 100. At the time, as explained above, the external stimulus may be a physical stimulus such as light, heat, an electric signal, and a magnetic signal or a chemical change such as pH change. For example, the transmitter 140 and the linker 130 may be bonded with each other to make the bond between the transmitter 140 and the linker 130 cleavable by an UV ray. In other words, the step S1030 may be performed to ester-bond the transmitter 140 and the linker 130. When an UV ray with a wavelength of 350 nm is provided to the polymer structure 100 produced by performing the steps S1020 to S1040 to cause the linker 130 and the transmitter 140 to be ester-bonded with each other on condition that the transmission mediator 120 is polyurea, a C—O bond from the ester bond between the linker 130 and the transmitter 140 may be cleavable and the transmitter 140 may be separated from the polymer structure 100.

When the polymer structure 100 is produced by using the method illustrated in FIG. 10, the transmitter 140 bonded with the linker 130 is formed on the transmission mediator 120 aligned in one direction by the MLD. The bond between the linker 130 and the transmitter 140 may be easily cleavable by the external stimulus. Accordingly, it is possible to produce the polymer structure 100 where it is easy to control a time of separating the transmitter 140 from the polymer structure 100 by adjusting strength of the external stimulus, etc. Accordingly, the method of producing this example embodiment is available in a field of drug delivery where it is important to control the time and amount of separating the transmitter 140, and also in other various fields.

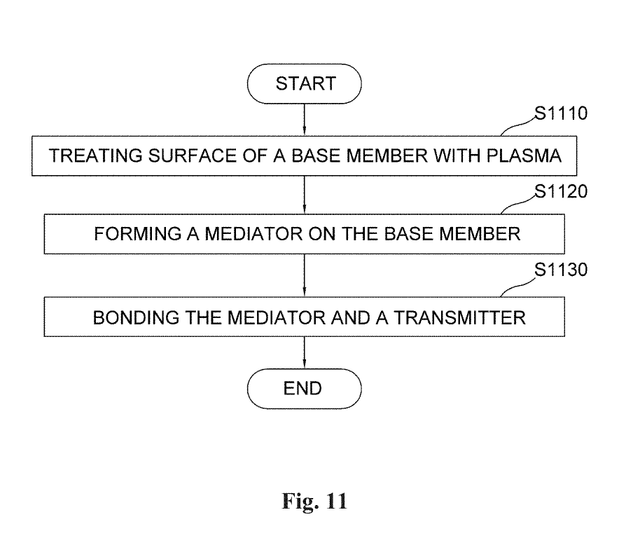

FIG. 11 is a flowchart representing performance of another example embodiment of a method of producing a polymer structure in accordance with the present invention.

By referring to FIG. 11, in another example embodiment of the method of producing the polymer structure in accordance with the present invention, the surface of the base member 610, first of all, may be treated with plasma at S1110. At the time, the plasma may be oxygen plasma.

As the base member 610 has the same shape and functions as the base member illustrated and explained in FIG. 6, the shape of the polymer structure 600 is determined. The base member 610 may be a nanostructure, and more desirably, a nanowire. The transmission mediator 620 may be easier to be formed as desired functional groups of the base member 610 is formed by treating the surface of the base member 610 with plasma. For example, the surface of the base member 610 may be treated with oxygen plasma to form hydroxyl radicals on the surface of the base member 610. If the desired functional groups are formed on the surface of the base member 610, a step S1110 may be omitted.

Next, the transmission mediator 620 is formed on the base member 610 at S1120. The transmission mediator 620 is made of polymer and it is formed by the MLD. This may cause the transmission mediator 620 to be formed in a shape aligned in one direction. For example, the polyester urethane transmission mediator 620 may be formed on the base member 610 by the MLD by supplying PDI and TBE reciprocally. The method of forming the polyester urethane transmission mediator 620 by the MLD is the same as the method illustrated and explained in FIG. 7. As such, when using the MLD, the transmission mediator 620 aligned in one direction may be formed on the base member 610.

After that, the transmission mediator 620 and the transmitter 640 are bonded with each other at S1130. The transmitter 640 has the same shape and functions as the transmitter as illustrated and explained in FIG. 6. By using the MLD, the transmitter 640 and the transmission mediator 620 may be bonded with each other. A step S1130 is performed to make the bond between the transmission mediator 620 and the transmitter 640 cleavable by an external stimulus. This may cause the polymer structure 600 where the transmission mediator 620 and the transmitter 640 are formed in due order on the base member 610 to be produced. The transmitter 640 may be protein, DNA, RNA, a drug, etc. and if the transmitter 640 is a drug, the polymer structure 600 may be used as a drug delivery substance.

The transmission mediator 620 may be formed to allow at least one of bonds making the transmission mediator 620 as well as the bond between the transmission mediator 620 and the transmitter 640 to be cleavable by an external stimulus. At the time, the bond between the transmission mediator 620 and the transmitter 640 or bonds making the transmission mediator 620 are cleavable by the same type of external stimulus provided to the polymer structure 600. In other words, the transmitter 640 may be separated from the polymer structure 600 in a shape of all partial cleavages between the transmission mediator 620 and the transmitter 640 which are formed on the base member 610 by cleaving several bonds, including the bond between the transmission mediator 620 and the transmitter 640 and multiple bonds in the transmission mediator 620, by one external stimulus.

As such, when an external stimulus is provided to the polymer structure 600 formed, the bond between the transmission mediator 620 and the transmitter 640 is cleaved and then the transmitter 640 is separated from the polymer structure 600. At the time, the external stimulus may be a physical stimulus such as light, heat, an electric signal, and a magnetic signal. A single physical stimulus or combinations of multiple types of physical stimuli may be provided to the polymer structure 600. In short, both the transmitter 640 and the transmission mediator 620 may be made of substances which may cause the bond between the transmitter 140 and the transmission mediator 620 to be cleavable by the physical stimulus. For example, the transmitter 640 and the transmission mediator 620 may be bonded with each other to lead the bond between them to be cleavable by an UV ray. In other words, a step S1130 may be performed to make the transmitter 640 and the transmission mediator 620 ester-bonded with each other.

When an UV ray with a wavelength of 350 nm is provided to the polymer structure 600 produced by performing the steps S1120 to S113 to make the transmission mediator 620 and the transmitter 640 ester-bonded with each other on condition that the transmission mediator 620 is polyester urethane, a C—O bond of the ester bond between the transmission mediator 620 and the transmitter 640 is cleaved and also multiple C—O bonds in the polyester urethane transmission mediator 620 are cleaved (Refer to FIG. 8) and therefore, the transmitter 640 may be separated from the polymer structure 600.

In addition, the external stimulus may be a chemical change. The chemical change may be an acidic or alkaline environment. In other words, at S1130, the transmitter 640 and the transmission mediator 620 may be bonded with each other to make the bond between the transmitter 640 and the transmission mediator 620 cleavable by a chemical change such as pH change.

When the polymer structure 600 is produced by using the method as illustrated in FIG. 11, the transmitter 640 is bonded with the transmission mediator 620 aligned in one direction by the MLD and the bond between the transmission mediator 620 and the transmitter 640 and multiple bonds in the transmission mediator 620 are cleavable easily by an external stimulus. Therefore, the polymer structure 600 where the transmitter 640 is cleavable may be produced. In addition, the polymer structure 600 from which it is easy to control a time and amount of separating the transmitter 640 by adjusting strength of the external stimulus, etc. may be produced. Accordingly, the method of producing this example embodiment is available in a field of drug delivery where it is important to control the time and amount of separating the transmitter 140, and also in other various fields.

In accordance with the present invention, because a transmission mediator as polymer may be aligned in one direction without being tangled by being formed by MLD, the transmitter may be separated from a polymer structure rapidly and accurately by an external stimulus compared to a conventional case of using a randomly oriented transmission mediator.

It is easy to control a time of cleaving the transmitter, concentration of the cleaved transmitter, etc. because alignment of functional groups on the surface of the transmission mediator may be controlled and have excellent reproducibility by using the MLD.

In addition, deposition is easy to be made even on a nanostructure and production of the desired design of a polymer structure is fast and easy compared to existing reaction to a solution by using the MLD which uses molecules in a gaseous state with high energy and excellent penetration.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polymer structure, comprising:
a base member;
a polymer mediator formed by molecular layer deposition (MLD) on the base member;
a linker formed on the mediator; and
a transmitter bonded with the linker;
wherein a bond between the linker and the transmitter is cleavable by an external stimulus.

2. A polymer structure, comprising:
a base member,
a polymer mediator formed by MLD on the base member, and
a transmitter bonded with the mediator,
wherein a bond between the mediator and the transmitter is cleavable by an external stimulus.

3. The polymer structure of claim 1, wherein the linker is formed by the MLD.

4. The polymer structure of claim 3, wherein the linker is formed as one molecular layer.

5. The polymer structure of claim 2, wherein at least one bond forming the mediator is cleavable by an external stimulus.

6. The polymer structure of claim 5, wherein any of the bond between the mediator and the transmitter and the bond forming the mediator, which are cleavable by the external stimulus, are cleavable by the same external stimulus.

7. The polymer structure of one of claim 1, wherein the mediator is a polymer thin film aligned in one direction.

8. The polymer structure of claim 7, wherein the external stimulus is a physical stimulus.

9. The polymer structure of claim 8, wherein the physical stimulus is at least one of light, heat, an electric signal, and a magnetic signal.

10. The polymer structure of claim 7, wherein the external stimulus is a chemical change.

11. The polymer structure of claim 10, wherein the chemical change is an acidic or alkaline environment.

12. The polymer structure of claim 7, wherein the base member is a nanostructure.

13. The polymer structure of claim 12, wherein the nanostructure is a nanowire.

14. The polymer structure of claim 7, wherein the transmitter is a drug.

15. The polymer structure of claim 7, wherein the mediator is formed on the base member whose surface is treated with plasma.

16. The polymer structure of claim 1, wherein the mediator is polyurea and the linker and the transmitter are ester-bonded with each other.

17. The polymer structure of claim 16, wherein the external stimulus is an UV ray and the ester bond between the linker and the transmitter is cleaved by the UV ray.

18. The polymer structure of claim 2, wherein the mediator is polyester urethane and the mediator and the transmitter are ester-bonded with each other.

19. The polymer structure of claim 18, wherein the external stimulus is an UV ray and the ester bond between the mediator and the transmitter is cleaved by the UV and at least one of C—O bonds in the polyester urethane is cleaved.

20. The polymer structure of one of claim 2, wherein the mediator is a polymer thin film aligned in one direction.

21. The polymer structure of claim 20, wherein the external stimulus is a physical stimulus.

22. The polymer structure of claim 21, wherein the physical stimulus is at least one of light, heat, an electric signal, and a magnetic signal.

23. The polymer structure of claim 20, wherein the external stimulus is a chemical change.

24. The polymer structure of claim 23, wherein the chemical change is an acidic or alkaline environment.

25. The polymer structure of claim 20, wherein the base member is a nanostructure.

26. The polymer structure of claim 25, wherein the nanostructure is a nanowire.

27. The polymer structure of claim 20, wherein the transmitter is a drug.

28. The polymer structure of claim 20, wherein the mediator is formed on the base member whose surface is treated with plasma.
